(19) United States
(12) Patent Application Publication
(10) Pub. No.: US 2022/0119106 A1
(43) Pub. Date: Apr. 21, 2022

(54) Aircraft for Performing Observations in the Stratosphere

(71) Applicant: SIEC BADAWCZA LUKASIEWICZ - INSTYTUT LOTNICTWA, Warszawa (PL)

(72) Inventor: Rafal Zurawski, Warszawa (PL)

(21) Appl. No.: 17/432,004

(22) PCT Filed: Feb. 19, 2020
(86) PCT No.: PCT/PL2020/000019

§ 371 Date: Aug. 18, 2021

(30) Foreign Application Priority Data
Feb. 19, 2019 (PL) P.428973

(51) Int. Cl. B64C 39/02; B64D 47/00; B64C 1/26; B64D 37/04; B64D 37/34

(52) U.S. Cl. CPC B64C 39/024; B64D 47/00; B64C 1/26; B64C 2201/127; B64D 37/34; B64C 2201/021; B64D 37/04

(57) ABSTRACT

An aircraft is equipped with a telescope built in the fuselage, with the initial angular mirror installed in the open part of the fuselage and the main mirror installed in the cylindrical part of the fuselage. The open part of the fuselage represents an open observation cavity with the base made of the bottom arc section of the fuselage rigidly connected with the nose of the aircraft. The main mirror is permanently fixed at the end of the cylindrical part of the fuselage at the tail. The initial angular mirror is rotary fixed to the nose. The axis of rotation of the initial angular mirror overlaps the longitudinal axis of the aircraft and the optical axis of the main mirror. The bottom arc section of the fuselage has a recess for observation of the earth, and the lifting surface is releasably fixed to the cylindrical part of the fuselage .

### TECHNICAL FIELD

The subject of the invention is aircraft for performing observations in the stratosphere, being an unmanned aircraft equipped with a telescope built in the fuselage for performing astronomic observations, observations of the ground, and taking aerial photos.

### BACKGROUND

Patent application W02017130137 describes various aerial constructions adapted for long-term unmanned flights in the stratosphere as an alternative for satellites in different missions such as observations, weather monitoring, telecommunications, and the like. A drone according to this patent application has a closed nose part adapted for cargo of different sizes, including scientific instrumentation and a camera. The nose part with the camera has a window for observations.

U.S. Pat. No. 4/858,850 discloses manned aircraft with a classic telescope installed on its board. Observations are performed through an open cavity located in the side wall of the fuselage. This solution has been applied in the SOFIA project on board a B-747 to perform observations during flight in the stratosphere. U.S. Pat. No. 5/678,787 describes a solution wherein the fuselage is equipped with an assembly of side and top doors that allows for opening during flight of the fuselage segment with optical devices for observation of atmospheric and extrasolar phenomena. These solutions necessitate rework of the fuselage and application of means reducing turbulences caused by an open cavity. Moreover, they only allow observation of one half-sphere during a flight in one direction.

Patent application GB1290144 discloses an optical device to perform observations through a window made in the side wall of the aircraft fuselage. The device is equipped with a camera having an axis of rotation parallel to the longitudinal axis of the fuselage and with angular mirror located in front of the lens with a reflection surface tilted at an angle of 45 degrees to the camera axis. This solution makes it possible to use optical devices for observations of a length exceeding the fuselage width.

Patent application US2009251773 discloses various configurations of a telescope integrated with a low-orbit satellite body. According to this solution, subassemblies of the telescope are located in the articulated cylindrical segments of the satellite, wherein the segment with the initial angular mirror has an open cavity for performing observations. This solution cannot be used in aerial construction designed for flights in the earth's atmosphere.

### BRIEF SUMMARY

An objective of the invention is to simplify the construction of an unmanned stratospheric aircraft with a fuselage integrated with a telescope.

An aircraft for performing observations in the stratosphere is equipped with a telescope built in the fuselage with an initial angular mirror installed in an open part of the fuselage and a main mirror installed in the cylindrical part of the fuselage. According to the invention, the aircraft can be characterized in that the open part of the fuselage represents an open observation cavity with a base made by the bottom arc section of the fuselage rigidly connected with the aircraft nose, a top mirror is permanently fixed at the end of the cylindrical part of the fuselage, at the tail, and the initial angular mirror is rotary fixed to the nose. An axis of rotation of the initial angular mirror overlaps the longitudinal axis of the aircraft and an optical axis of the main mirror, the bottom arc section of the fuselage has a recess for observation of the earth, and the lifting surface of the aircraft is releasably fixed to the cylindrical part of the fuselage.

It is preferred if the initial angular mirror is rotary fixed in a bearing fixed to the rear part of the nose and is controlled using a servomotor installed to the nose construction.

It is also preferred if the lifting surface is fixed to the fuselage using a split yoke in the shape of a ring, consisting of a separately installed bottom yoke and a top yoke permanently fixed to the cylindrical part of the fuselage.

According to a preferred embodiment, the cylindrical part of the fuselage is made in the form of double-walled fuel tank connected with the aircraft engine supply system. According to this solution, it is preferred if the double-walled fuel tank is connected with the main mirror cooling system using a pump.

Solutions according to the invention are used by the cylindrical fuselage of the aircraft as a telescope tube of length exceeding the fuselage diameter, depending on the focal point of the main mirror. Utilization of the initial angular mirror with configurable position allows for observation of the whole sphere within the range of 360° at a given azimuth. This allows observation of a given object after changing direction of flight to opposite, therefore allowing for determining a narrow closed space for research purposes. Application of the unmanned technology allows for optimizing the construction from the standpoint of the performed missions and a significant reduction of costs. According to another variation of the aircraft, the fuselage can be made as a double-walled fuel tank and the fuel can be used as a medium cooling the main mirror.

### BRIEF DESCRIPTION OF THE DRAWINGS

The invention is presented as an embodiment in the drawing.

FIG. 1 presents a top view of an aircraft according to the teachings herein.

FIG. 2 presents a bottom view of the aircraft.

FIG. 3 presents an isometric view of the aircraft with a partial cross-section of the nose and fuselage.

FIG. 4 presents an isometric view of a version of the aircraft with a partial cross-section of the nose and fuselage.

FIG. 5 presents a variation of the aircraft of FIG. 4 with partial cross-section of the tail.

### DETAILED DESCRIPTION

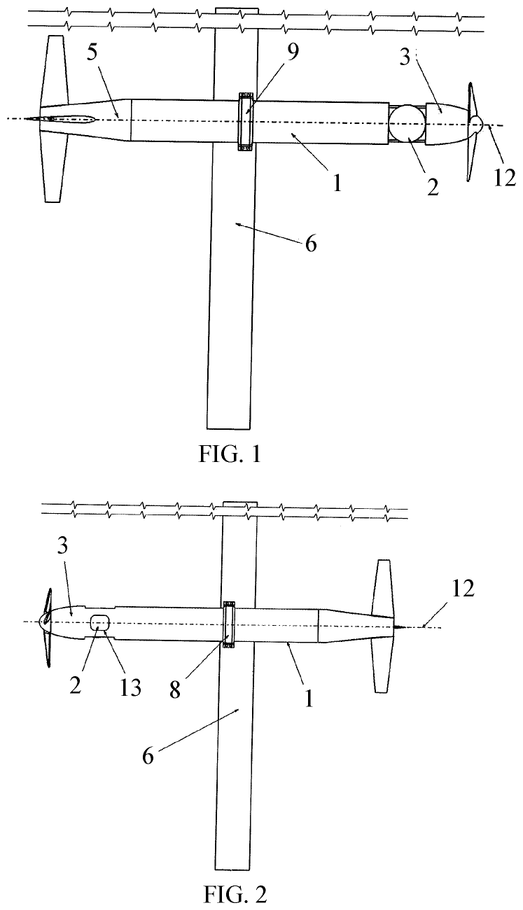

As presented in FIGS. 1-3, the aircraft has a fuselage 1 connected with the nose 3 and tail 5 as well as lifting surface 6 fixed to the fuselage 1 using a separate yoke in the shape of a ring, consisting of the bottom yoke 8 and top yoke 9. The top yoke 9 is permanently fixed to the fuselage 1 and the bottom yoke 8 is fixed releasably. The fuselage 1 is equipped with subassemblies of the telescope for astronomic observations and observations of the earth. The longitudinal axis 12 of the aircraft overlaps the axis of the cylindrical part of the fuselage 1. An engine is installed in the nose 3.

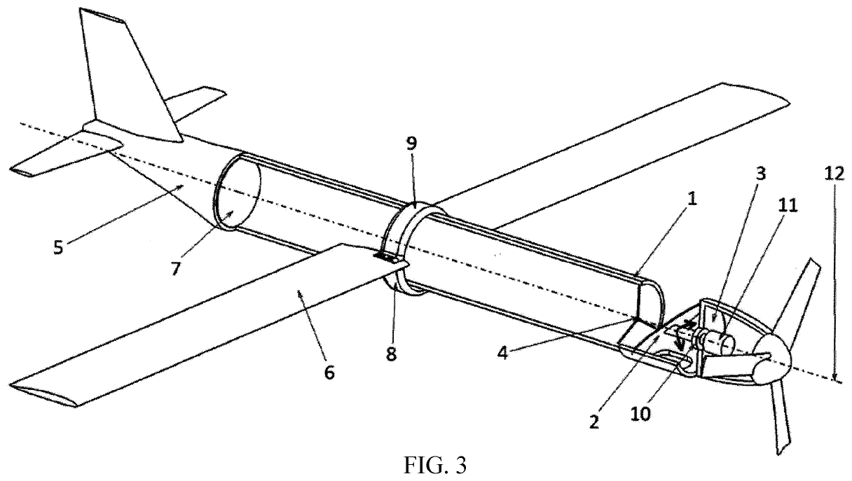

The fuselage 1 has a shape of a cylinder with a cut out observation cavity at the front, the basis of which is formed by the bottom arc section of the fuselage 1 rigidly connected with the nose 3 of the aircraft. The arc section of the fuselage 1 has a recess 13. The observation cavity has the initial angular mirror 2 of the telescope rotary installed to the nose 3. The remaining subassemblies of the telescope, including electromagnetic spectrum detector 4 and main mirror 7, shown in FIG. 3, are installed in the cylindrical part of the fuselage 1. The cylindrical part of the fuselage 1 presents a tube of the telescope. The electromagnetic spectrum detector 4 recording optical data, the nose 3, the top mirror 2, the fuselage 1, and the tail 5 are permanently fixed in relation to each other, forming a rigid construction of the airframe. The main mirror 7 is permanently fixed at the end of the cylindrical part of the fuselage 1 at the tail 5. The axis of rotation of the initial angular mirror 2 overlaps the longitudinal axis 12 of the aircraft and the optical axis of the main mirror 7.

The recess 13 enables observations of the earth surface after rotation of the initial angular mirror 2 by 180°. The initial angular mirror 2 is rotary fixed in a bearing 10 fixed to the rear part of the nose 3 and is controlled using a servomotor 11 installed to the nose 3 construction. The lifting surface 6 consists of a left and a right wing. The releasably installed bottom yoke 8 allows the reconfiguration of the airframe using wings of different elongations adapted to the profile of the mission and facilitates transport of the aircraft itself.

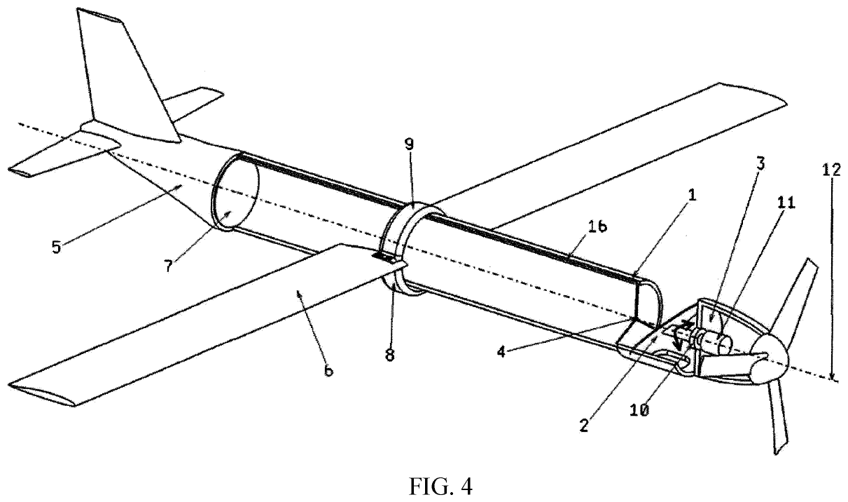

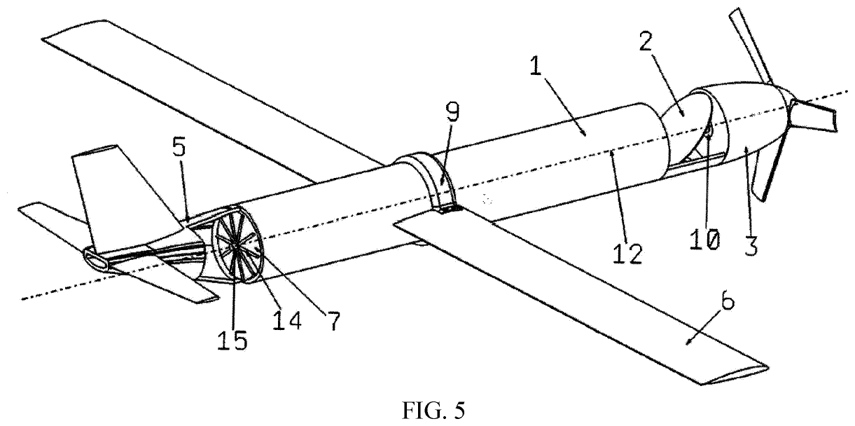

The version of the aircraft presented in FIG. 4 differs in that the cylindrical part of the fuselage 1 is made in the form of double-walled fuel tank 16 connected with the aircraft engine supply system. Fuel fills the narrow cylindrical space between the external and internal jacket of the tank 16, leaving free space inside the internal jacket for the telescope subassemblies. According to this embodiment, fuel present in the double-walled tank 16 can be used as a cooling medium for cooling the main mirror 7. To this end, the double-walled tank 16 is connected with the cooling system 14 of the main mirror 7, as shown in FIG. 5, using the pump 15. The cooling system 14 and the pump 15 are fixed to the rear non-reflective part of the main mirror 7. Circulation of fuel as a cooling medium is forced by the pump 15.

Water steam in the atmosphere stops the cosmic infrared radiation that can be observed only at altitudes to 11-12 thousand meters, when 99% of the water steam is present below. Therefore, there is a need to fly at high altitudes while performing astronomic observations in near infrared. During day flights and with the initial angular mirror oriented downwards, it is possible to take aerial photos with high resolution at different electromagnetic spectrum bands for commercial purposes. This kind of a “flying telescope” for the visible band can be used both by amateur astronomers, using the optics of the commercially available Ritchey-Chretien (RC) telescope, as an amateur instrument for performing observations and astrophotography as well as a professional research instrument of the main mirror diameter in the order of meters for various ranges of electromagnetic waves. High resolution capabilities of the telescope allow for performing reconnaissance missions for military and civil purposes such as monitoring of borders, recognition of targets or search and rescue (SAR) operations.

1. An aircraft for performing observations in the stratosphere equipped with a telescope built in a fuselage of the aircraft with an initial angular mirror installed in an open part of the fuselage and a main mirror installed in a cylindrical part of the fuselage, wherein:
the open part of the fuselage represents an open observation cavity with a base made by a bottom arc section of the fuselage rigidly connected with a nose of the aircraft,
the top mirror is permanently fixed at an end of the cylindrical part of the fuselage, at a tail of the aircraft,
the initial angular mirror is rotary fixed to the nose,
an axis of rotation of the initial angular mirror overlaps a longitudinal axis of the aircraft and an optical axis of the main mirror,
the bottom arc section of the fuselage has a recess for observation of the earth, and
a lifting surface of the aircraft is releasably fixed to the cylindrical part of the fuselage.

2. The aircraft according to claim 1, wherein the initial angular mirror is rotary fixed in a bearing fixed to a rear part of the nose and is controlled using a servomotor installed to the nose.

3. The aircraft according to claim 1, wherein the lifting surface is fixed to the fuselage using a split yoke in the shape of a ring, the split yoke comprises a bottom yoke and a top yoke, and the top yoke is permanently fixed to the cylindrical part of the fuselage.

4. The aircraft according to claim 1, wherein the cylindrical part of the fuselage is made in the form of double-walled fuel tank connected with an engine supply system of the aircraft.

5. The aircraft according to claim 4, wherein the double-walled fuel tank is connected with a cooling system of the main mirror using a pump.
